(19) United States
(12) Patent Application Publication
(10) Pub. No.: US 2021/0016924 A1
(43) Pub. Date: Jan. 21, 2021

(54) CONTAINER SEAL

(71) Applicant: YNB SUPPLY (ASIA) CORPORATION, New Taipei City (TW)

(72) Inventor: YEN-WU YANG, NEW TAIPEI CITY (TW)

(21) Appl. No.: 16/695,943

(22) Filed: Nov. 26, 2019

(30) Foreign Application Priority Data
Jul. 19, 2019 (CN) 201921137794.0

(51) Int. Cl. B65D 17/34

(52) U.S. Cl. CPC B65D 17/34; B65D 2517/0013

(57) ABSTRACT

A container seal includes an inner element and an outer element. The inner element has at least one through hole. The outer element is adhered to the inner element and is releasable from the inner element. The container seal is conducive to preventing a user from being stained with contents of a container covered with the container seal while tearing the container seal. The container seal can be pierced by a soft straw whereby the user sucks the contents of the container.

### CROSS-REFERENCE TO RELATED APPLICATION

This non-provisional application claims priority under 35 U.S.C. § 119(a) on Patent Application No(s). 201921137794.0 filed in China on Jul. 19, 2019, the entire contents of which are hereby incorporated by reference.

### BACKGROUND OF THE INVENTION

### 1. Field of the Invention

The present disclosure relates to container seals, and in particular to a two-element container seal.

### 2. Description of the Related Art

The opening of a conventional container which contains food, drink, drug, or the like (hereinafter referred to as the contents) is usually covered with a seal. The seal protects the contents in the container against contamination, as the seal prevents the contents from coming into contact with the outside. The seal has to be torn or pierced in order to open the container and use the contents.

However, from a user perspective, the conventional seal has two drawbacks. First, to tear the seal by hand, a user is likely to end up with a finger stained by the contents. Second, before starting to suck the contents into his or her mouth with a straw, the user pierces the seal with the straw; to this end, the straw must be made of rigid material in order to be strong enough to pierce the seal. However, for the sake of environmental protection, conventional straws are made of paper or plastic and thus too weak to pierce the seal.

### BRIEF SUMMARY OF THE INVENTION

An objective of the present disclosure is to provide a container seal which comprises: an inner element having at least one through hole; and an outer element adhered to the inner element and releasable from the inner element.

Regarding the container seal, an adhesive layer is adhered to a surface of the outer element, and the outer element is adhered to the inner element by the adhesive layer.

Regarding the container seal, the outer element is partially coupled to the inner element.

The container seal further comprises a lug coupled to an edge of the outer element.

Regarding the container seal, the lug protrudes from an edge of the inner element.

Regarding the container seal, the through hole of the inner element is in a round, starlike, square, elliptic, or polygonal shape.

Regarding the container seal, the inner element has a plurality of through holes.

The container seal is conducive to preventing a user from being stained with contents of a container covered with the container seal while tearing the container seal. The container seal can be pierced by a soft straw whereby the user sucks the contents of the container.

### BRIEF DESCRIPTION OF THE DRAWINGS

FIG. 1 is an exploded view of a container seal according to embodiment 1 of the present disclosure.

FIG. 2 is a cross-sectional view of a container seal according to embodiment 1 of the present disclosure.

FIG. 3 is an exploded view of a container seal according to embodiment 2 of the present disclosure.

FIG. 4 is an exploded view of a container seal according to embodiment 3 of the present disclosure.

FIG. 5 is a cross-sectional view of a container seal according to embodiment 4 of the present disclosure.

FIG. 6 is an exploded view of a container seal according to embodiment 5 of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

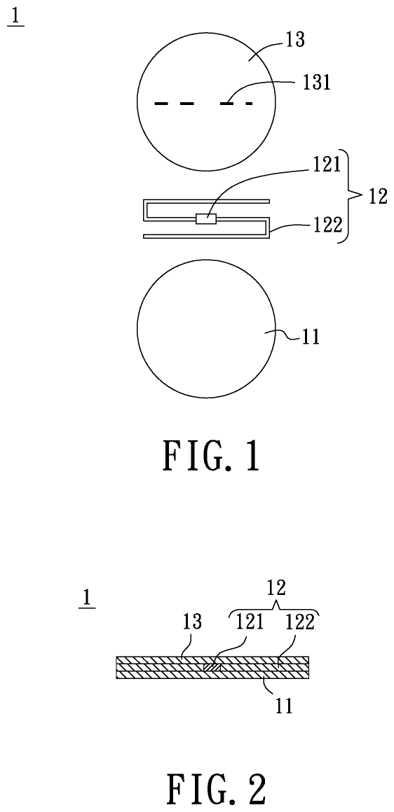

The embodiment 1 of the present disclosure provides a container seal 1. Referring to FIG. 1, the container seal 1 comprises an inner element 11 and an outer element 12. The inner element 11 is adapted to adhere to an opening (not shown) of a container. The container is, for example, a bottle, can, box or aluminum foil package. The inner element 11 has a through hole 110. The outer element 12 is adhered to the inner element 11 and releasable from the inner element 11. The container seal 1 hermetically seals a container (not shown) which contains a drink. To access the drink in the container, a user can easily tear the outer element 12 to reveal the inner element 11, and the drink can be discharged from the container via the through hole 110 of the inner element 11; hence, the user either sips the drink which passes through the through hole 110 or pours the drink into a container. Alternatively, the user can choose to suck the drink with a straw (not shown) after inserting the straw into the through hole 110.

The drink can stain a part of the outer element 12, that is, the part which faces the through hole 110. The edge of the outer element 12 prevents the user's hand from coming into contact with the drink because of the inner element 11 in direct contact with the container opening. Hence, after tearing the outer element 12 by hand, the user's fingers are not stained with the drink. Furthermore, unlike what is disclosed in the prior art, the uses can still drink the drink with a soft straw, because the outer element 12 can be easily torn off from the inner element 11 to reveal the through hole 110 of the inner element 11, allowing the soft straw to be inserted into the through hole 110.

In embodiment 1, the inner element 11 is made of polyethylene (PE). However, in a variant embodiment, the inner element 11 is made of polyethylene terephthalate (PET), polypropylene, or any other well-known sealing material. Hence, the present disclosure is not restricted to embodiment 1.

In embodiment 1, the outer element 12 is made of aluminum plastic composite material. However, in a variant embodiment, the outer element 12 is made of polypropylene, polyethylene terephthalate (PET), or any other well-known non-toxic, waterproof material. Hence, the present disclosure is not restricted to embodiment 1.

Referring to FIG. 2, an adhesive layer 13 is adhered to the outer element 12 and positioned proximate to the inner element 11, and thus the outer element 12 is adhered to the inner element 11 by the adhesive layer 13. The adhesive layer 13 is made of low-adherence, readily-released silicone material. However, in a variant embodiment, the adhesive layer 13 is made of aqueous acrylic, rubber or any other well-known low-adherence, readily-released plastic material. Hence, the present disclosure is not restricted to embodiment 1. With the outer element 12 being made of aluminum plastic composite material and its aluminum layer being made of conductive material, the container seal 1 seals the container tightly for the reason described below. After the container opening has been covered with the container seal 1, the container is placed in an electromagnetic induction sealing machine such that electric current is generated from the aluminum material in the container seal 1 by electromagnetic induction. The electric current flows and generates heat. Finally, the outer element 12 is heated up to thereby melt the adhesive layer 13.

In embodiment 1, the through hole 110 is in a round shape. However, in a variant embodiment, the through hole 110 is in a starlike, square, elliptic, polygonal or any other shape, as needed.

The embodiment 1 and the embodiments to be described below is exemplified by a container which contains a drink. However, in a variant embodiment, the container seal 1 covers the opening of a container which contains food, drug or any other edible article.

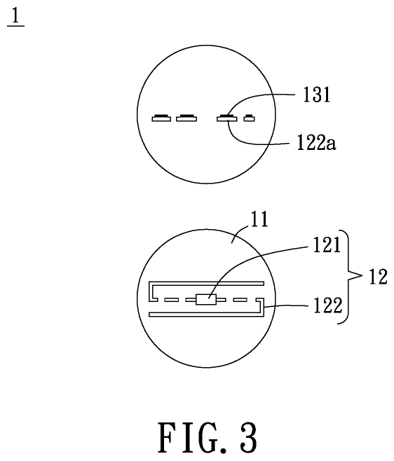

Embodiment 2 of the present disclosure provides a container seal 2. Referring to FIG. 3, the container seal 2 of embodiment 2 is substantially the same as the container seal 1 of embodiment 1 except for the technical features described below. In embodiment 2, the outer element 22 of the container seal 2 has a plurality of coupling points 221. The outer element 22 is adhered to the inner element 21 by the coupling points 221 only. The outer element 22 is partially coupled to the inner element 21. Hence, the strength of the bonding between the outer element 22 and the inner element 21 is low, allowing the outer element 22 to be peeled off from the inner element 21. However, in a variant embodiment, the coupling points 221 of the outer element 22 and the inner element 21 are coupled together by hot pressing or the like. Hence, the present disclosure is not restricted to embodiment 2.

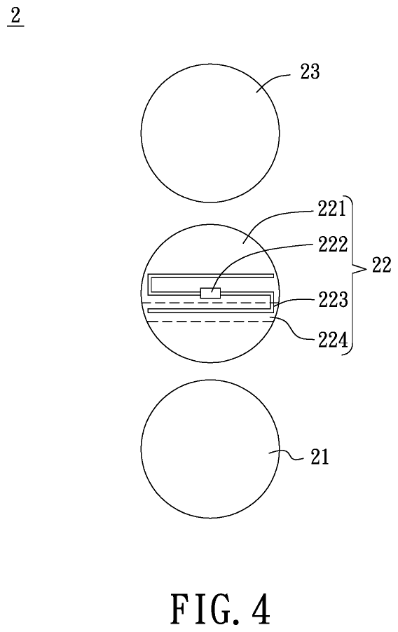

Embodiment 3 of the present disclosure provides a container seal 3, Referring to FIG. 4, the container seal 3 of embodiment 3 is substantially the same as the container seal 1 of embodiment 1 except for the technical features described below. The container seal 3 further comprises a lug 33. The lug 33 is coupled to the edge of the outer element 32. The user grips the lug 33 and pulls the outer element 32 upward; hence, the user takes less effort to tear and lift the outer element 32 off from the inner element 31.

In embodiment 3, the lug 33 protrudes from an edge of the inner element 31. Hence, the lug 33 is not adhered to the inner element 31 and the outer element 32 such that the user can grip the lug 33 easily. However, in a variant embodiment, the lug 33 does not protrude from an edge of the inner element 31. Hence, the present disclosure is not restricted to embodiment 3.

In embodiment 3, the lug 33 and the outer element 32 are integrally formed. However, in a variant embodiment, the lug 33 is a self-contained element coupled to the outer element 32.

In embodiment 3, the lug 33 is in a hemispheric shape. However, in a variant embodiment, the lug 33 is in a slender, hemispheric arcuate, square, or polygonal shape or any shape, as needed.

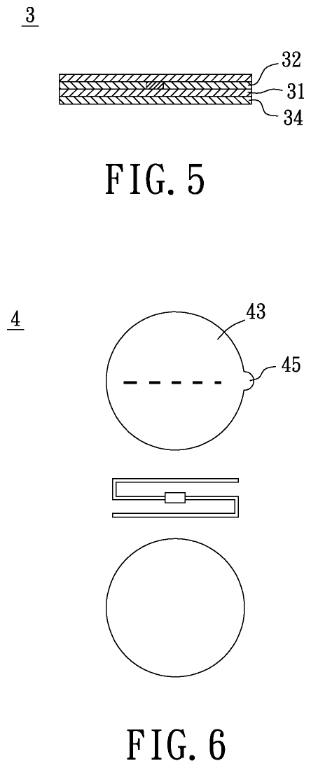

Embodiment 4 of the present disclosure provides a container seal 4. Referring to FIG. 5, container seal 4 of embodiment 4 is substantially the same as the container seal 1 of embodiment 1 except for the technical features described below. The inner element 41 has a plurality of through holes 410. The through holes 410 enable the container seal 4 to hermetically seal the opening of a drug container.

Thread is disposed on the inner sidewall of a cover of a conventional package container for commercially-available drug or food additive such that the cover can be rotated to open, allowing the drug or food additive to be conveniently taken out and better protected against contamination. Since the container seal 4 has the through holes 410, the user can pour out particulate drug or food additive through the through holes 410. To seal the container hermetically again, the user covers the container seal 4 with a cover which is easy to manufacture and made of little plastic material and is of a conventional shape. Hence, the die-opening and material costs incurred in designing the cover as a rotatable, threaded cover are greatly reduced.

Embodiment 5 of the present disclosure provides a container seal 5, Referring to FIG. 6, the container seal 5 of embodiment 5 is substantially the same as the container seal 1 of embodiment 1 except for the technical features described below. The through holes 510 is in a starlike shape.

As described above, the container seal is conducive to preventing a user from being stained with contents of a container covered with the container seal while tearing the container seal. The container seal can be pierced by a soft straw whereby the user sucks the contents of the container. Owing to the lug, the user takes less effort to release the outer element from the inner element. Owing to the plurality of through holes, the container seal replaces a rotatable, threaded cover, so as to greatly reduce the die-opening and material costs incurred in designing the cover as a rotatable, threaded cover.

While the present disclosure has been described by means of specific embodiments, numerous modifications and variations could be made thereto by those skilled in the art without departing from the scope and spirit of the present disclosure set forth in the claims.

What is claimed is:

1. A container seal, comprises:
an inner element having at least one through hole; and
an outer element adhered to the inner element and releasable from the inner element.

2. The container seal of claim 1, wherein an adhesive layer is adhered to a surface of the outer element, and the outer element is adhered to the inner element by the adhesive layer.

3. The container seal of claim 1, wherein the outer element is partially coupled to the inner element.

4. The container seal of claim 1, further comprising a lug coupled to an edge of the outer element.

5. The container seal of claim 4, wherein the lug protrudes from an edge of the inner element.

6. The container seal of claim 2, further comprising a lug coupled to an edge of the outer element.

7. The container seal of claim 6, wherein the lug protrudes from an edge of the inner element.

8. The container seal of claim 3, further comprising a lug coupled to an edge of the outer element.

9. The container seal of claim 8, wherein the lug protrudes from an edge of the inner element.

10. The container seal of claim 1, wherein the through hole of the inner element is in a round, starlike, square, elliptic, or polygonal shape.

11. The container seal of claim 1, wherein the inner element has a plurality of through holes.
